(19) United States
(12) Patent Application Publication
(10) Pub. No.: US 2016/0216841 A1
(43) Pub. Date: Jul. 28, 2016

(54) TOUCH PANEL AND TOUCH PANEL EQUIPPED DISPLAY DEVICE

(71) Applicant: SHARP KABUSHIKI KAISHA, Osaka (JP)

(72) Inventors: Toshimitsu GOTOH, Osaka (JP); Masayuki HATA, Osaka (JP)

(73) Assignee: Sharp Kabushiki Kaisha, Osaka (JP)

(21) Appl. No.: 14/916,938

(22) PCT Filed: Aug. 19, 2014
(86) PCT No.: PCT/JP2014/071667

§ 371 Date: Mar. 4, 2016

(30) Foreign Application Priority Data
Sep. 10, 2013 (JP) 2013-186974

(51) Int. Cl. G06F 3/041; G06F 3/044

(52) U.S. Cl. CPC G06F 3/0418; G06F 3/044; G06F 2203/04111

(57) ABSTRACT

A touch panel includes: a first sensor unit that includes first transmission electrodes and first receiving electrodes; a second sensor unit that includes second transmission electrodes and second receiving electrodes; a transmission unit that provides a drive signal to the first transmission electrodes and the second transmission electrodes; and a receiving unit that receives a plurality of output signals from the first receiving electrodes and the second receiving electrodes. The first sensor unit has a first sensing region and a blank region. The second sensor unit has a second sensing region and a wiring region. The second sensing region is formed to the inside of the blank region in a plan view.

### TECHNICAL FIELD

The present invention relates to a touch panel and a touch panel display device, and more specifically relates to a capacitive touch panel and a display device equipped with this type of touch panel.

### BACKGROUND ART

Touch panel display devices that are configured to, by overlapping a touch panel and a display panel, operate while the display panel is being viewed are conventionally well-known.

Japanese Patent Application Laid-Open Publication No. 2011-76515 discloses a capacitive touch panel upon which is formed a plurality of rows of transparent first detection electrodes that extend in a first direction and a plurality of rows of transparent second detection electrodes that extend in a second direction that intersects the first direction.

### SUMMARY OF THE INVENTION

When a capacitive touch panel becomes larger, the distance between the point at which the capacitance is being measured and driver circuits/detection circuits becomes larger. Thus, the time constant of the transmission route becomes larger, and it takes longer to measure the capacitance of the entire touch panel.

The electrodes on the touch panel are formed via a transparent conductive film such as ITO (indium tin oxide), for example. Transparent conductive films have a higher electrical resistance than a metal or the like. Thus, the time constant of the transmission routes is large, which makes it difficult to increase the size of the touch panel. Meanwhile, when the electrodes are formed via a metal, the electrodes becomes easily visible, which decreases display quality; thus, it is not preferable to form the electrodes using a metal.

An object of the present invention is to obtain a configuration of a touch panel that reduces the amount of time for measuring the capacitance of the entire touch panel.

The touch panel disclosed here includes: a first sensor unit that includes first transmission electrodes and first receiving electrodes; a second sensor unit that includes second transmission electrodes and second receiving electrodes; a transmission unit that provides a drive signal to the first transmission electrodes and the second transmission electrodes; and a receiving unit that receives a plurality of output signals from the first receiving electrodes and the second receiving electrodes, wherein the first sensor unit has a first sensing region where the first transmission electrodes and the first receiving electrodes intersect in a plan view, and a blank region where none of the first transmission electrodes and the first receiving electrodes are formed, wherein the second sensor unit has a second sensing region where the second transmission electrodes and the second receiving electrodes intersect in a plan view, and a wiring region in which either only the second transmission electrodes or only the second receiving electrodes are formed, and wherein the second sensing region is formed so as to overlap the blank region in a plan view.

According to the present invention, it is possible to obtain a configuration of a touch panel that reduces the amount of time for measuring the capacitance of the entire touch panel.

### BRIEF DESCRIPTION OF THE DRAWINGS

FIG. 1 is a cross-sectional view of a schematic configuration of a touch panel display device according to an embodiment of the present invention.

FIG. 2 is a plan view that shows only a substrate and the first sensor unit from the configuration of the touch panel.

FIG. 3 is a cross-sectional view along the line III-III in FIG. 2.

FIG. 4 is a plan view that shows only the substrate and the second sensor unit from the configuration of the touch panel.

FIG. 5 is a cross-sectional view along the line V-V of FIG. 4.

FIG. 6 is a cross-sectional view along the line VI-VI of FIG. 4.

FIG. 7 is a cross-sectional view along the line VII-VII of FIG. 4.

FIG. 8 is a functional block diagram that shows a functional configuration of the touch panel.

FIG. 9 is a functional block diagram that shows a functional configuration of a touch panel according to a hypothetical comparative example.

FIG. 10 is a plan view of an example of a receiving electrode.

FIG. 11 is a plan view of an example of a receiving electrode.

FIG. 12 is a cross-sectional view that shows a schematic configuration of a modification example of the touch panel according to Embodiment 1 of the present invention.

FIG. 13 is a plan view showing only a substrate and a first sensor unit from the configuration of a touch panel according to a modification example.

FIG. 14 is a plan view showing only a substrate and a second sensor unit from the configuration of the touch panel according to the modification example.

FIG. 15 is a cross-sectional view that shows a schematic configuration of another modification example of a touch panel according to Embodiment 1 of the present invention.

FIG. 16 is a plan view showing only a substrate and a first sensor unit from the configuration of the touch panel according to the modification example.

FIG. 17 is a plan view showing only a substrate and a second sensor unit from the configuration of the touch panel according to the modification example.

FIG. 18 is a cross-sectional view that shows a schematic configuration of a touch panel according to Embodiment 2 of the present invention.

FIG. 19 is a plan view showing a schematic configuration of a first substrate.

FIG. 20 is a plan view showing a schematic configuration of a second substrate.

### DETAILED DESCRIPTION OF EMBODIMENTS

A touch panel according to an embodiment of the present invention includes: a first sensor unit that includes first transmission electrodes and first receiving electrodes; a second sensor unit that includes second transmission electrodes and second receiving electrodes; a transmission unit that provides drive signals to the first transmission electrodes and the second transmission electrodes; and a receiving unit that receives output signals from the first receiving electrodes and the second receiving electrodes. The first sensor unit includes a first sensing region that is formed such that the first transmission electrodes and the first receiving electrodes intersect in a plan view, and a blank region in which no first transmission electrodes or first receiving electrodes are formed. The second sensor unit includes a second sensing region where the second transmission electrodes and the second receiving electrodes intersect in a plan view, and wiring regions in which either only second transmission electrodes or only second receiving electrodes are formed. The second sensing region is formed to the inside of the blank region in a plan view (Configuration 1).

According to the above-mentioned configuration, the first sensing region is formed such that the first transmission electrodes and the first receiving electrodes intersect thereon. As a finger or the like approaches the first sensing region, the capacitance between the first transmission electrode and the first receiving electrode changes. The transmission unit provides drive signals to the first transmission electrode. The receiving unit receives output signals from the first receiving electrode. According to this configuration, it is possible to detect changes in capacitance between the first transmission electrode and the first receiving electrode.

Similarly, the second sensing region is formed such that the second transmission electrodes and the second receiving electrodes intersect thereon. As a finger or the like approaches the second sensing region, the capacitance between the second transmission electrode and the second receiving electrode changes. The transmission unit provides drive signals to the second transmission electrode. The receiving unit receives output signals from the second receiving electrode. According to this configuration, it is possible to detect changes in capacitance between the second transmission electrode and the second receiving electrode.

The first sensor unit has, in addition to the first sensing region, a blank region in which no first transmission electrodes or first receiving electrodes are formed. The second sensing region is formed to the inside of the blank region in a plan view. Thus, the second sensing region is not electrically shielded by the first sensor unit.

In order to accurately measure changes in capacitance, it is preferable that the area in which the first transmission electrodes and the first receiving electrodes overlap in a plan view be small. This is because, in the sections in which the first transmission electrodes and the first receiving electrodes overlap in a plan view, one electrode is shielded by the other. The situation is identical for the second transmission electrodes and the second receiving electrodes.

The second sensor unit has, in addition to the second sensing region, wiring regions in which either only second transmission electrodes or only second receiving electrodes are formed. In the wiring regions, it is not necessary to take into account the overlap, like that mentioned above, of the second transmission electrodes and the second receiving electrodes. Thus, in the wiring regions, it is possible to lower the electrical resistance by increasing the width of the second transmission electrodes or the second receiving electrodes.

By including the wiring regions, it is possible to decrease the size of the time constant of the transmission routes between the transmission unit/receiving unit and the second sensing region. Thus, it is possible to reduce the amount of time necessary to measure the second sensing region. In this manner, it is possible to reduce the amount of time necessary to measure the capacitance of an entire touch panel 10.

In the above-mentioned Configuration 1, the electrical resistance per unit length of the second transmission electrodes in the wiring regions may be configured so as to be smaller than the electrical resistance per unit length of the second transmission electrodes in the second sensing region (Configuration 2).

In either Configuration 1 or Configuration 2, the electrical resistance per unit length of the second receiving electrodes in the wiring regions may be configured so as to be smaller than the electrical resistance per unit length of the second receiving electrodes in the second sensing region (Configuration 3).

In any one of Configurations 1 to 3, the touch panel may be configured such that: the touch panel further includes a substrate, the first sensor unit is formed on one surface of the substrate, and the second sensor unit is formed on another surface of the substrate (Configuration 4).

In any one of Configurations 1 to 3, the touch panel may be configured such that: the touch panel further includes a first substrate, and a second substrate disposed so as to overlap the first substrate; the first sensor unit is formed on the first substrate; and the second sensor unit is formed on the second substrate (Configuration 5).

In Configuration 5, the touch panel may be configured such that: the first transmission electrodes are formed on one surface of the first substrate, the first receiving electrodes are formed on another surface of the first substrate, the second transmission electrodes are formed on one surface of the second substrate, and the second receiving electrodes are formed on another surface of the second substrate (Configuration 6).

A touch panel display device according to an embodiment of the present invention includes a display panel disposed on a side of the touch panel, which has any one of Configurations 1 to 6 mentioned above, facing the second sensor unit (configuration of the touch panel display device).

### Embodiments

Embodiments of the present invention will be described in detail below with reference to the drawings. Portions in the drawings that are the same or similar are assigned the same reference characters and descriptions thereof will not be repeated. For ease of description, drawings referred to below show simplified or schematic configurations, and some of the components are omitted. Components shown in the drawings are not necessarily to scale.

### Embodiment 1

### Overall Configuration

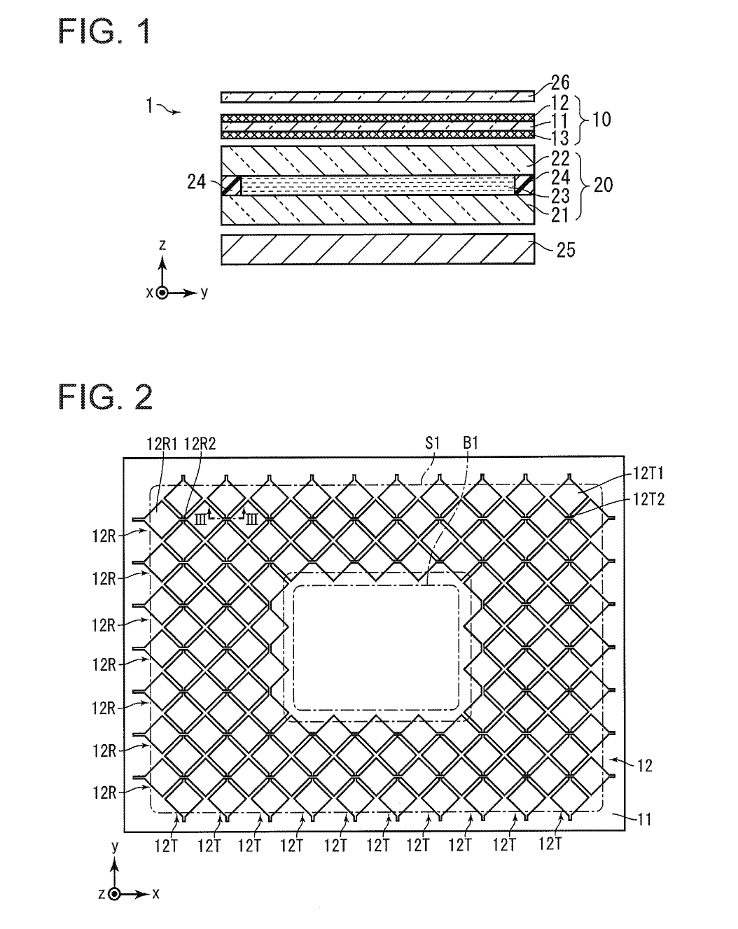

FIG. 1 is a cross-sectional view of a schematic configuration of a touch panel display device 1 according to an embodiment of the present invention. The touch panel display device 1 includes: tempered glass 26; a touch panel 10; a liquid crystal display panel 20; and a backlight unit 25.

The touch panel 10 is disposed so as to overlap the surface of the liquid crystal display panel 20 opposite to the backlight unit 25. The touch panel 10 is bonded to the liquid crystal display panel 20 via an OCA (optical clear adhesive).

The touch panel 10 includes a substrate 11. The substrate 11 is transparent and has insulating properties. The substrate 11 is a glass substrate, for example. The substrate 11 may be a transparent resin film.

A first sensor unit 12 and a second sensor unit 13 are formed on the substrate 11. The first sensor unit 12 and the second sensor unit 13 are formed on different surfaces of the substrate 11. Specifically, the first sensor unit 12 is formed on a surface of the substrate 11 opposite to the liquid crystal display panel 20. The second sensor unit 13 is formed on a surface of the substrate 11 that faces the liquid crystal display panel 20. A detailed configuration of the first sensor unit 12 and the second sensor unit 13 will be provided later.

The liquid crystal display panel 20 includes: a TFT (thin film transistor) substrate 21; a CF (color filter) substrate 22; liquid crystal 23; and a sealant 24. The TFT substrate 21 and the CF substrate 22 are disposed so as to face each other. The sealant 24 is formed at the periphery of the opposing faces of the TFT substrate 21 and the CF substrate 22. The liquid crystal 23 is sealed between the TFT substrate 21 and the CF substrate 22.

While a detailed configuration is not shown in the drawings, the TFT substrate 21 includes a plurality of pixel electrodes. The liquid crystal display panel 20, by controlling the potential of these pixel electrodes, controls the alignment of the liquid crystal 23. By so doing, the liquid crystal display panel 20 expresses gradation by controlling the behavior of light received from the backlight unit 25.

<Configuration of the First Sensor Unit 12>

FIG. 2 is a plan view that shows only the substrate 11 and the first sensor unit 12 from the configuration of the touch panel 10. As mentioned above, the first sensor unit 12 is formed on a surface of the substrate 11 opposite to the liquid crystal display panel 20.

The first sensor unit 12 includes a plurality of transmission electrodes (first transmission electrodes) 12T, and a plurality of receiving electrodes (first receiving electrodes) 12R. The plurality of transmission electrodes 12T are formed in parallel to each other so as to each extend in the same direction. The plurality of receiving electrodes 12R are formed in parallel to each other so as to each extend in a direction substantially perpendicular to the transmission electrodes 12T.

Hereafter, the extension direction of the transmission electrodes 12T is referred to as the y direction, and the extension direction of the receiving electrodes 12R is referred to as the x direction. The direction normal to the substrate 11 is referred to as the z direction.

The first sensor unit 12 has a first sensing region S1 formed such that the transmission electrodes 12T and the receiving electrodes 12R intersect in a plan view, and a blank region B1 in which no transmission electrodes 12T or receiving electrodes 12R are formed.

In the present embodiment, the blank region B1 is formed in the center of the substrate 11, and the first sensing region S1 is formed so as to surround the blank region B1.

In the first sensing region S1, the transmission electrodes 12T and the receiving electrodes 12R are capacitively coupled. When a finger or the like approaches the first sensing region S1, the capacitance between the transmission electrodes 12T and the receiving electrodes 12R changes. As will be explained later, the touch panel 10 calculates the location of the finger or the like that approached the first sensing region S1 by detecting this change in capacitance.

The transmission electrodes 12T respectively include: a plurality of island sections 12T1 disposed along the y direction, and connecting sections 12T2 that connect adjacent island sections 12T1 to each other. Similarly, the receiving electrodes 12R respectively include: a plurality of island sections 12R1 disposed along the x direction, and connecting sections 12R2 that connect adjacent island sections 12R1 to each other.

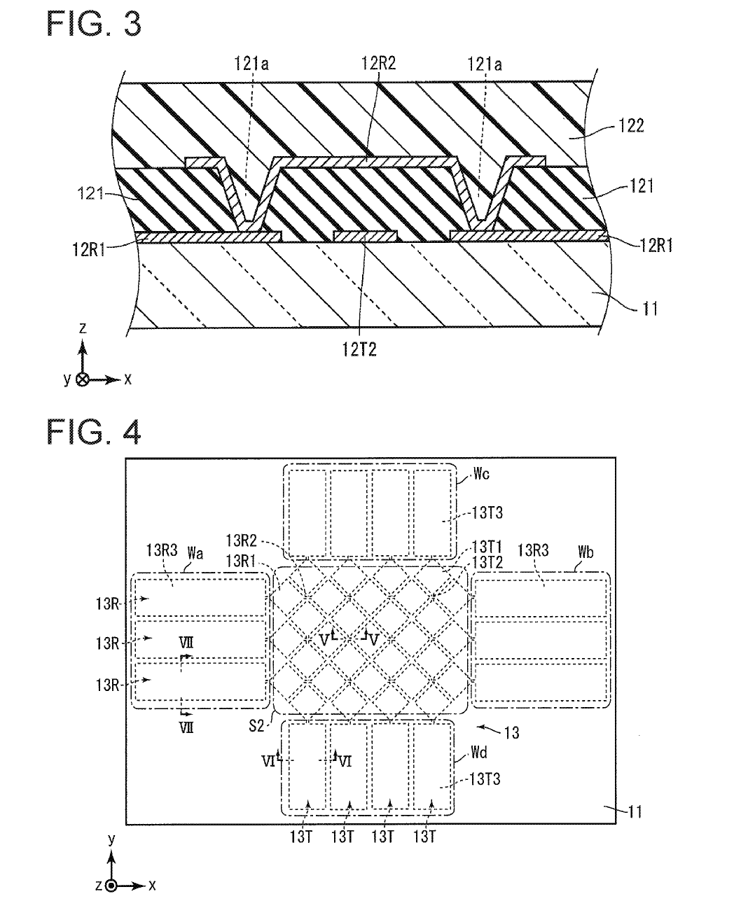

FIG. 3 is a cross-sectional view along the line III-III of FIG. 2. As shown in FIG. 3, the connecting sections 12T2 of the transmission electrodes 12T and the island sections 12R1 of the receiving electrodes 12R are formed so as to contact the substrate 11. While not shown in the cross-section of FIG. 3, the island sections 12T1 of the transmission electrodes 12T also are formed so as to contact the substrate 11.

Meanwhile, the connecting sections 12R2 of the receiving electrodes 12R sandwich an interlayer insulating film 121 therebetween, and are formed in a different layer than the island sections 12T1, the island sections 12R1, and the connecting sections 12T2. The island section 12R1 and the connecting section 12R2 of the receiving electrode 12R contact each other via a contact hole 121a formed in the interlayer insulating film 121. As a result of this configuration, it is possible to have the transmission electrodes 12T and the receiving electrodes 12R intersect in a plan view without contacting each other.

The connecting sections 12T2 of the transmission electrodes 12T and the interlayer insulating film 121 are covered by a protective film 122.

It is preferable that the area in which the transmission electrodes 12T and the receiving electrodes 12R overlap in a plan view be small. Thus, the width (the dimension in the x direction) of the connecting sections 12T2 is formed narrower than the width (the dimension in the x direction) of the island sections 12T1. Similarly, the width (the dimension in the y direction) of the connecting sections 12R2 is formed narrower than the width (the dimension in the y direction) of the island sections 12R1.

The transmission electrodes 12T and the receiving electrodes 12R are transparent conductive films made of ITO or the like, for example. The transmission electrodes 12T and the receiving electrodes 12R are formed by sputtering, and patterned via photolithography, for example. The interlayer insulating film 121 is a transparent insulating film made of silicon nitride or the like, for example. The interlayer insulating film 121 is formed via CVD (chemical vapor deposition), and patterned via photolithography, for example. The protective film 122 is made of a transparent resin with an acrylic base, for example. The protective film 122 is formed via a spin coater or a slit coater, for example.

<Configuration of the Second Sensor Unit 13>

FIG. 4 is a plan view that shows only the substrate 11 and the second sensor unit 13 from the configuration of the touch panel 10. As mentioned above, the second sensor unit 13 is formed on a surface of the substrate 11 that faces the display device 20.

The second sensor unit 13 includes a plurality of transmission electrodes (second transmission electrodes) 13T, and a plurality of receiving electrodes (second receiving electrodes) 13R. The plurality of transmission electrodes 13T are formed in parallel to each other so as to each extend in the y direction. The plurality of receiving electrodes 13R are formed in parallel to each other so as to each extend in the x direction.

The second sensor unit 13 has a second sensing region S2 formed such that the transmission electrodes 13T and the receiving electrodes 13R intersect, and regions Wa to Wd in which either only transmission electrodes 12T or only receiving electrodes 12R are formed. Hereafter, the regions Wa to Wd will be referred to as “wiring regions.”

In the present embodiment, the second sensing region S2 is formed in the center of the substrate 11, and the wiring regions Wa to Wd are formed from the second sensing region S2 toward the outside of the substrate 11.

Specifically, only receiving electrodes 13R are formed in the wiring region Wa, which is located toward the minus side in the x direction from the center of the substrate 11. Similarly, only receiving electrodes 13R are formed in the wiring region Wb, which is located toward the plus side in the x direction from the center of the substrate 11. Meanwhile, only transmission electrodes 13T are formed in the wiring region Wc, which is located toward the plus side in the y direction from the center of the substrate 11. Similarly, only transmission electrodes 13T are formed in the wiring region Wd, which is located toward the minus side in the y direction from the center of the substrate 11.

The second sensing region S2 is disposed to the inside of the blank region B1 of the first sensor unit 12 in a plan view. As a result of this configuration, the second sensing region S2 is not electrically shielded by the first sensor unit 12.

In the second sensing region S2, the transmission electrodes 13T and the receiving electrodes 13R are capacitively coupled. As mentioned above, the second sensing region is not electrically shielded by the first sensor unit 12; thus, when a finger or the like approaches the second sensing region S2, the capacitance between the transmission electrode 13T and the receiving electrode 13R changes. Similar to the case for the first sensing region S1, the touch panel 10 calculates the location of the finger or the like that approached the second sensing region S2 by detecting this change in capacitance.

The transmission electrodes 13T respectively include: a plurality of island sections 12T1 arranged along the y direction, connecting sections 12T2 that connect adjacent island sections 12T1 to each other, and wiring units 13T3 that are formed in the wiring region We and the wiring region Wd. Similarly, the receiving electrodes 13R respectively include: a plurality of island sections 13R1 arranged along the x direction, connecting sections 13R2 that connect adjacent island sections 13R1 to each other, and wiring units 13T3 formed in the wiring region Wa and the wiring region Wb.

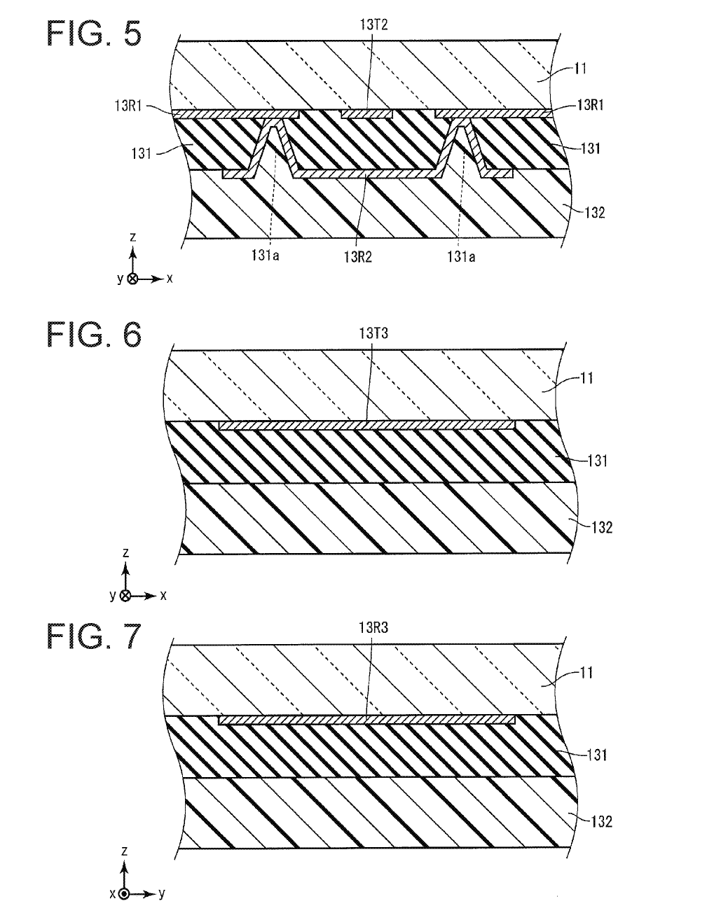

FIG. 5 is a cross-sectional view along the line V-V of FIG. 4. As a result of the configuration being the same as that for the first sensor unit 12, the transmission electrodes 13T and the receiving electrodes 13R intersect in a plan view without contacting each other. In FIG. 5, the reference character 131 refers to an interlayer insulating film, the reference character 132a refers to a contact hole, and the reference character 132 refers to a protective film. These respective elements are the same as the interlayer insulating film 131, the contact hole 131a, and the protective film 132 in the first sensor unit 12; thus, a detailed description thereof will be omitted.

FIG. 6 is a cross-sectional view along the line VI-VI of FIG. 4. FIG. 7 is a cross-sectional view along the line VII-VII of FIG. 4. In FIGS. 6 and 7, the configuration on the first sensor unit 11 side is omitted. As mentioned above, either only transmission electrodes 12T or only receiving electrodes 12R are formed in the respective wiring regions Wa to Wd. Thus, the transmission electrodes 12T and the receiving electrodes 12R do not intersect.

As was the case for the first sensor unit 12, it is preferable that the area in which the transmission electrodes 13T and the receiving electrodes 13R overlap in a plan view be small. Thus, the width (the dimension in the x direction) of the connecting sections 13T2 is formed narrower than the width (the dimension in the x direction) of the island sections 13T1. Similarly, the width (the dimension in the y direction) of the connecting sections 13R2 is formed narrower than the width (the dimension in the y direction) of the island sections 13R1.

Meanwhile, it is not necessary to take into account overlap of the transmission electrodes 13T and the receiving electrodes 13R in the wiring regions Wa to Wd. Thus, for the wiring units 13T3 formed in the wiring region Wc and the wiring region Wd, the width (the dimension in the x direction) can be increased and the electrical resistance reduced. Similarly, for the wiring units 13R3 formed in the wiring region Wa and the wiring region Wb, the width (the dimension in the y direction) can be increased and the electrical resistance reduced.

In other words, the electrical resistance per unit length of the transmission electrodes 13T in the wiring region Wc and the wiring region Wd is lower than the electrical resistance per unit length of the transmission electrodes 13T in the second sensing region S2. Similarly, the electrical resistance per unit length of the receiving electrodes 13R in the wiring region Wa and the wiring region Wb is lower than the electrical resistance per unit length of the receiving electrodes 13R in the second sensing region S2.

The width (the dimension in the x direction) of the wiring unit 13T3 is formed wider than at least the width (the dimension in the x direction) of the connecting section 13T2. It is preferable that the width (the dimension in the x direction) of the wiring unit 13T3 be formed as wide as possible while not allowing for short circuits with adjacent wiring units 13T3. Similarly, the width (the dimension in the y direction) of the wiring unit 13R3 is formed wider than the width (the dimension in the y direction) of at least the connecting section 13R2. It is preferable that the width (the dimension in the y direction) of the wiring unit 13R3 be formed as wide as possible while not allowing for short circuits with adjacent wiring units 13T3.

<Configuration of Entire Touch Panel 10>

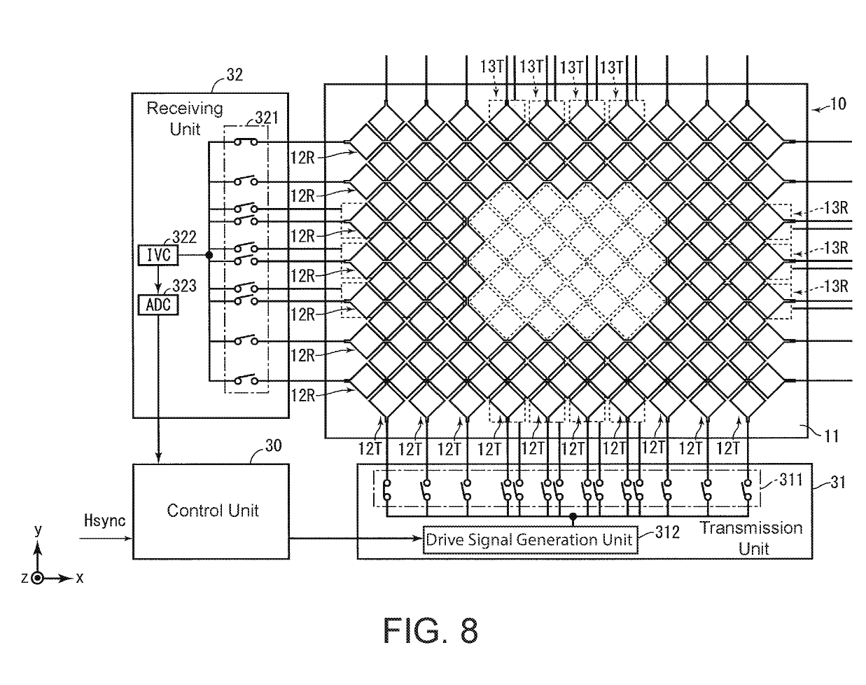

FIG. 8 is a functional block diagram that shows a functional configuration of the touch panel 10. The touch panel 10 further includes: a control unit 30, a transmission unit 31, and a receiving unit 32. The control unit 30, the transmission unit 31, and the receiving unit 32 are connected to the first sensor unit 12 and the second sensor unit 13 via an FPC (flexible printed circuit) or the like, for example.

The control unit 30 controls the transmission unit 31 and the receiving unit 32 and measures changes in capacitance in the sensor unit 12 and the sensor unit 13.

The transmission unit 31 includes a multiplexer 311, and a drive signal generation unit 312. The multiplexer 311 selects one electrode from the plurality of transmission electrodes 12T and the plurality of transmission electrodes 13T, and connects the selected electrode to the drive signal generation unit 312. The drive signal generation unit 312 generates a drive signal in accordance with the control of the control unit 30, and provides the signal to the electrode selected by the multiplexer 311.

The receiving unit 32 includes: a multiplexer 321; a current to voltage converter (IVC or I/V converter) 322; and an analog/digital converter (ADC or A/D converter) 323. The multiplexer 321 selects one electrode from the plurality of receiving electrodes 12R and the plurality of receiving electrodes 13R and connects the selected electrode to the IVC 322. The IVC 322 receives an output signal from the electrode selected by the multiplexer 321, converts the received output signal from current to voltage, and then outputs the signal to the ADC 323. The ADC 323 converts the received signal from an analog signal into a digital signal, and sends the digital signal to the control unit 30.

While not fully shown in FIG. 8, respective contact points of the multiplexer 311 in the transmission unit 31 are connected in parallel to both ends in the y direction of the respective transmission electrodes 12T and transmission electrodes 13T. In this manner, drive signals generated by the drive signal generation unit 312 are provided from both ends in the y direction to the respective transmission electrodes 12T and transmission electrodes 13T.

Similarly, the respective contact points of the multiplexer 321 in the receiving unit 32 are connected in parallel to both ends in the x direction of the respective receiving electrodes 12R and receiving electrodes 13R. In this manner, output signals received by the IVC 322 are read from both ends in the x direction of the respective receiving electrodes 12R and receiving electrodes 13R.

According to the above-mentioned configuration, the control unit 30 is able to measure the capacitance at the intersection of the electrode selected by the multiplexer 311 and the electrode selected by the multiplexer 321. The control unit 30 then scans the transmission electrodes 12T, the transmission electrodes 13T, the receiving electrodes 12R, and the receiving electrodes 13R, and measures the capacitance at each intersection point of these electrodes.

More specifically, the control unit 30 scans the transmission electrodes 12T and the receiving electrodes 12R, and measures the capacitance of all the intersection points formed in the first sensing region S1. Similarly, the control unit 30 scans the transmission electrodes 13T and the receiving electrodes 13R, and measures the capacitance of all the intersection points formed in the second sensing region S2.

The control unit 30 may be configured so as to measure the intersection capacitances for each transmission electrode, or may be configured to measure the intersection capacitances for each receiving electrode. Alternatively, the control unit 30 may be configured to measure the intersection capacitances in a desired order that is different from those described above.

The control unit 30 receives signals related to the intersection capacitances of the various electrodes from the receiving unit 32. The control unit 30 includes a storage device (not shown), and stores values sequentially transmitted by the receiving unit 32. The control unit 30 performs a prescribed calculation in accordance with the distribution of values stores in the storage device, and calculates the coordinates of the finger or the like that contacted or approached the first sensor unit 12 or the second sensor unit.

It is preferable that the control unit 30 receive a horizontal synchronization signal Hsync from the liquid crystal display panel 20 (FIG. 1) and operate the transmission unit 31 and the receiving unit 32 in synchronization with the operation of the liquid crystal display panel 20. More specifically, during an interval within one horizontal period in which the liquid crystal display panel 20 performs source writing, the noise level from the liquid crystal display panel 20 is high; thus it is preferable to operate the transmission unit 31 and the receiving unit 32 at a time other than this interval.

<Effects of the Touch Panel 10>

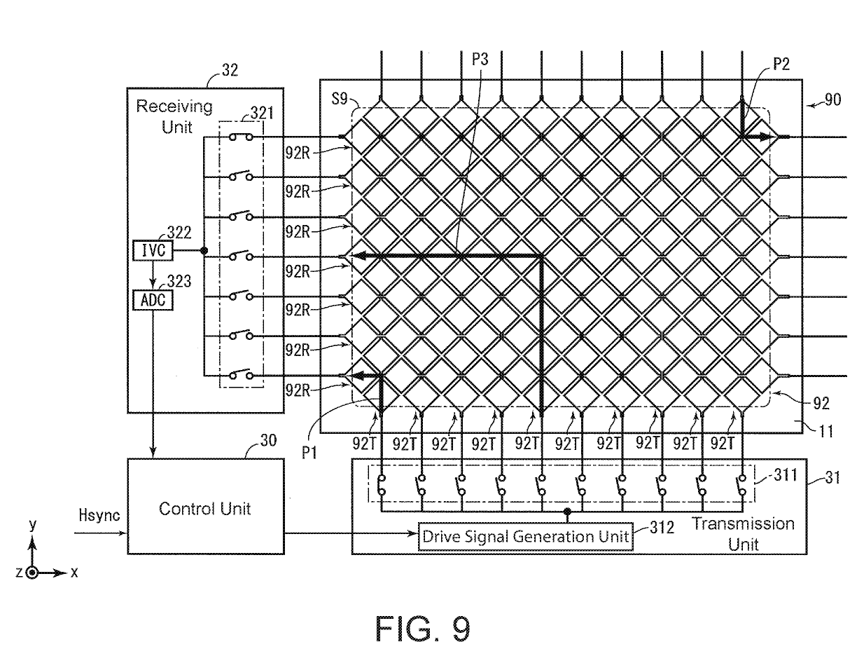

FIG. 9 is a functional block diagram that shows a functional configuration of a touch panel 90 according to a hypothetical comparative example used to illustrate the effect of the touch panel 10. The touch panel 90 includes a sensor unit 92 instead of the first sensor unit 12 and the second sensor unit 13 of the touch panel 10. The sensor unit 92 includes a plurality of transmission electrodes 92T and a plurality of receiving electrodes 92R.

The plurality of transmission electrodes 92T are formed in parallel to each other so as to each extend in the y direction. The plurality of receiving electrodes 92R are formed in parallel to each other so as to each extend in the x direction. The sensor unit 92 has a sensing region S9 formed such that the transmission electrodes 92T and the receiving electrodes 92R intersect in a plan view. The sensing region S9 is formed on most of the front surface of the substrate 11.

Similar to the touch panel 10, on the touch panel 90, the contact points of the multiplexer 311 of the transmission unit 31 are respectively connected in parallel to both ends in the y direction of the respective transmission electrodes 92T. In addition, the contact points of the multiplexer 321 of the receiving unit 32 are respectively connected in parallel to both ends in the x direction of the respective receiving electrodes 92R.

On the touch panel 90, the transmission routes from the transmission unit 31 and the receiving unit 32 become longer as the location of the intersection at which the capacitance is being measured becomes closer to the center of the substrate 11. For example, in FIG. 9, a transmission route P3, which passes through an area near the center of the substrate 11, is longer than a transmission route P1 and a transmission route P2, which both pass through areas near the periphery of the substrate 11. As the transmission route becomes longer, the time constant becomes larger and the amount of time necessary to perform measurement increases.

The touch panel 90 adjusts the driving timing using the time constant for the longest transmission route as a reference so that the capacitance at the location which has the longest transmission route can be measured. Thus, as the sensing region S9 becomes larger, the number of intersections increases and the measurement time for each point becomes longer. Therefore, as the sensing region S9 becomes larger, the amount of time necessary to measure the entire sensing region S9 becomes larger at an accelerated rate.

As a countermeasure, on the touch panel 10 according to the present embodiment, the sensing region is divided into the first sensing region S1 (FIG. 2) formed on the first sensor unit 12, and the second sensing region S2 (FIG. 3) formed on the second sensor unit 13.

The first sensor unit 12 has the blank region B1 in addition to the first sensing region S1. The second sensing region S2 is disposed to the inside of the blank region B1 in a plan view. Thus, the second sensing region S2 is not electrically shielded by the first sensor unit.

The second sensor unit 13 has the wiring regions Wa to Wd in addition to the second sensing region S2. As mentioned above, the electrical resistance per unit length of the transmission electrodes 13T and the receiving electrodes 13R in the wiring regions Wa to Wd is less than the electrical resistance per unit length of the transmission electrodes 13T and the receiving electrodes 13R in the second sensing region S2.

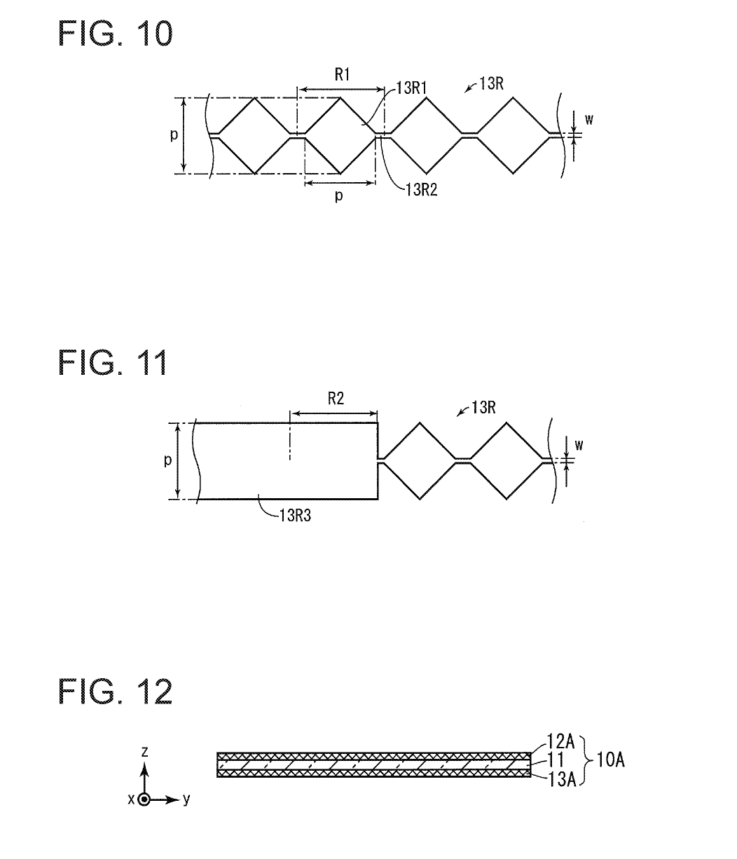

As shown in FIG. 10, when the receiving electrode 13R is made of ITO with a sheet resistance of 50Ω/sq, the dimensions of the island sections 13R1 are 4 mm×4 mm (p=4), and the width w of the connecting sections 13R2 is 0.1 mm, the electrical resistance R1 of one pattern, which includes island sections 13R1 and connecting sections 13R2, is approximately 270Ω, for example. As a countermeasure, when the wiring unit 13R3 has a width of 4 mm as shown in FIG. 11, it is possible to lower the electrical resistance R2 over a segment with the same length as that shown in FIG. 10 by approximately 2Ω.

By including the wiring regions Wa to Wd, it is possible to decrease the time coefficient of the transmission routes between the transmission unit 31/receiving unit 32 and the second sensing region S2. Thus, it is possible to reduce the amount of time necessary to measure the second sensing region S2. In this manner, it is possible to reduce the amount of time necessary to measure the capacitance of the entire touch panel 10.

Since measurement time is reduced, it is possible to prevent decreases in response speed when the touch panel is larger. That is to say, it is possible to realize a larger touch panel that has a response speed that falls within an acceptable range.

### Modification Example 1 of Embodiment 1

FIG. 12 is a cross-sectional view of a schematic configuration of a touch panel 10A that is a modification example of the touch panel 10. The touch panel 10A includes a first sensor unit 12A instead of the first sensor unit 12, and includes a second sensor unit 13A instead of the second sensor unit 13. Similar to the touch panel 10, the first sensor unit 12A and the second sensor unit 13A are formed on different surfaces of the substrate 11.

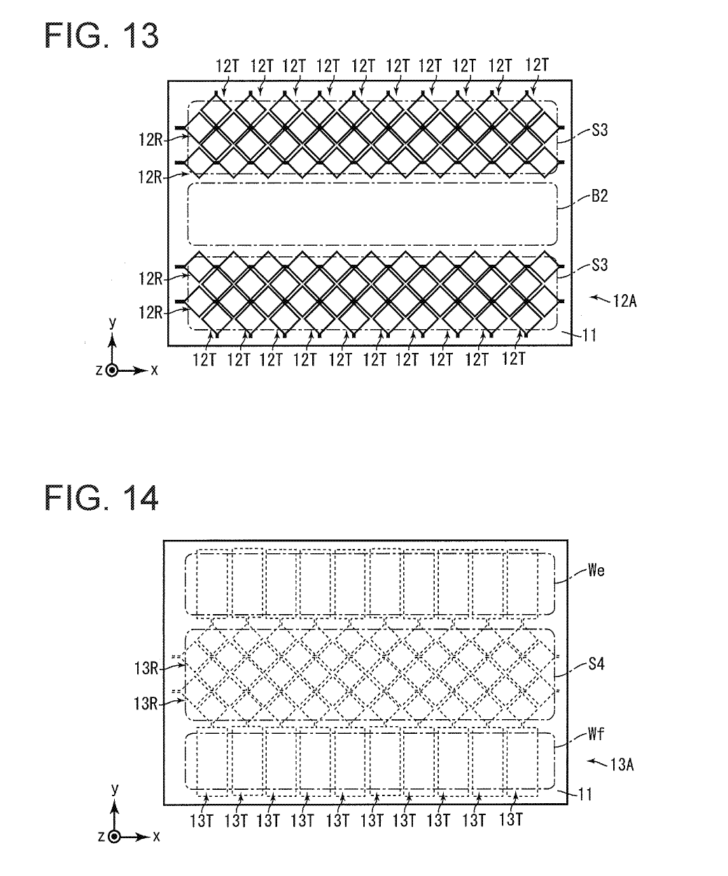

FIG. 13 is a plan view that shows only the substrate 11 and the first sensor unit 12A from the configuration of the touch panel 10A. Compared to the first sensor unit 12, the arrangement of the first sensing region and the blank region is different in the first sensor unit 12A. Specifically, in the first sensor unit 12A, the center of the substrate 11 in the y direction is a blank region B2, and first sensing regions S3 sandwiches the blank region B2 on the plus side and the minus side in the y direction of the substrate 11.

FIG. 14 is a plan view that only shows the substrate 11 and the second sensor unit 13A from the configuration of the touch panel 10A. Compared to the second sensor unit 13, the arrangement of the second sensing region and the wiring regions is different in the second sensor unit 13A. Specifically, in the second sensor unit 13A, the center of the substrate 11 in the y direction is a second sensing region S4, and the second sensing region S4 is sandwiched by a wiring region We on the plus side in the y direction of the substrate 11 and a wiring region Wf on the minus side in the y direction of the substrate 11.

In this modification example as well, the second sensing region S4 is disposed to the inside of the blank region B2 in a plan view. Thus, the second sensing region S4 is not electrically shielded by the first sensor unit 12A.

An effect identical to that of Embodiment 1 can be obtained via this modification example as well. In other words, it is possible to reduce the amount of time necessary to measure the second sensing region S4 by including the wiring region We and the wiring region Wf. Thus, it is possible to reduce the amount of time necessary to measure the second sensing region S4.

### Modification Example 2 of Embodiment 1

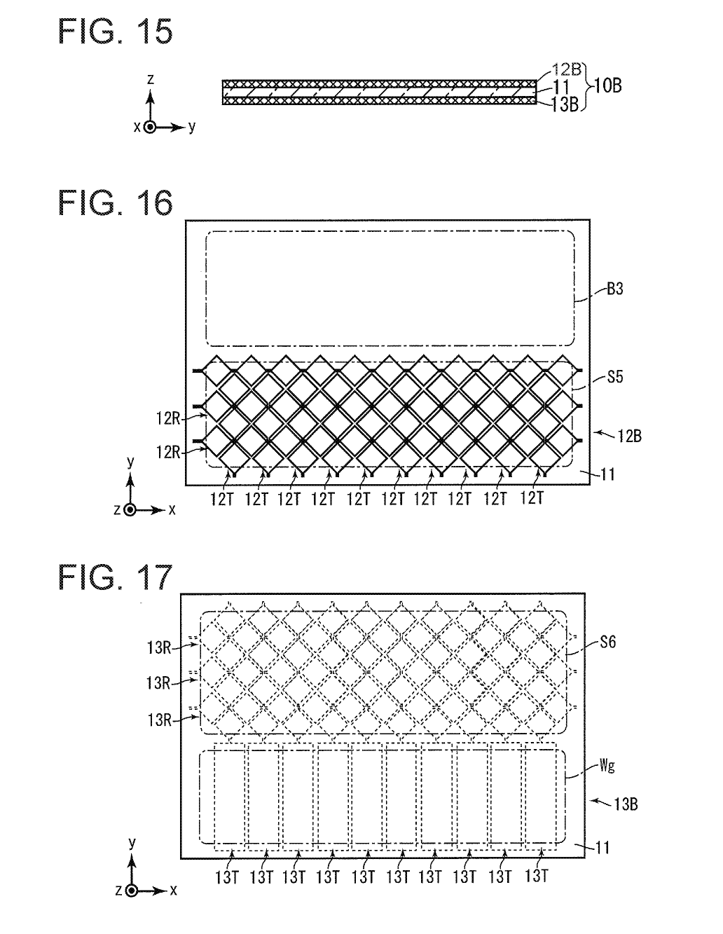

FIG. 15 is a cross-sectional view of a schematic configuration of a touch panel 10B that is a different modification example of the touch panel 10. The touch panel 10B includes a first sensor unit 12B instead of the first sensor unit 12, and includes a second sensor unit 13B instead of the second sensor unit 13. Similar to the touch panel 10, the first sensor unit 12B and the second sensor unit 13B are formed on different surfaces of the substrate 11.

FIG. 16 is a plan view of only the substrate 11 and the first sensor unit 12B from the configuration of the touch panel 10B. Compared to the first sensor unit 12, the arrangement of the first sensing region and the blank region is different in the first sensor unit 12B. Specifically, in the first sensor unit 12B, the half of the substrate 11 on the minus side in the y direction is a first sensing region S5, and the half of the substrate 11 on the plus side in the y direction is a blank region B3.

FIG. 17 is a plan view of only the substrate 11 and the second sensor unit 13B from the configuration of the touch panel 10B. Compared to the second sensor unit 13, the arrangement of the second sensing region and the wiring regions is different in the second sensor unit 13B. Specifically, in the second sensor unit 13B, the half of the substrate 11 on the plus side in the y direction is a second sensing region S6, and the half of the substrate 11 on the minus side in the y direction is a wiring region Wg.

In this modification example as well, the second sensing region S6 is disposed to the inside of the blank region B3 in a plan view. Thus, the second sensing region S6 is not electrically shielded by the first sensor unit 12B.

An effect identical to that of Embodiment 1 can be obtained via this modification example as well. In other words, it is possible to reduce the amount of time necessary to measure the second sensing region S6 by including the wiring region Wg. Thus, it is possible to reduce the amount of time necessary to measure the second sensing region S6.

The touch panel 10A and the touch panel 10B, which are modification examples of the touch panel 10 according to Embodiment 1 of the present invention, were described above. As is clear from these modification examples, the arrangement of the first sensing region and the second sensing region can be chosen as appropriate if the second sensing region is inside of the blank region in a plan view. An effect identical to that of the present embodiment can then be obtained if the second sensor unit has wiring regions.

### Embodiment 2

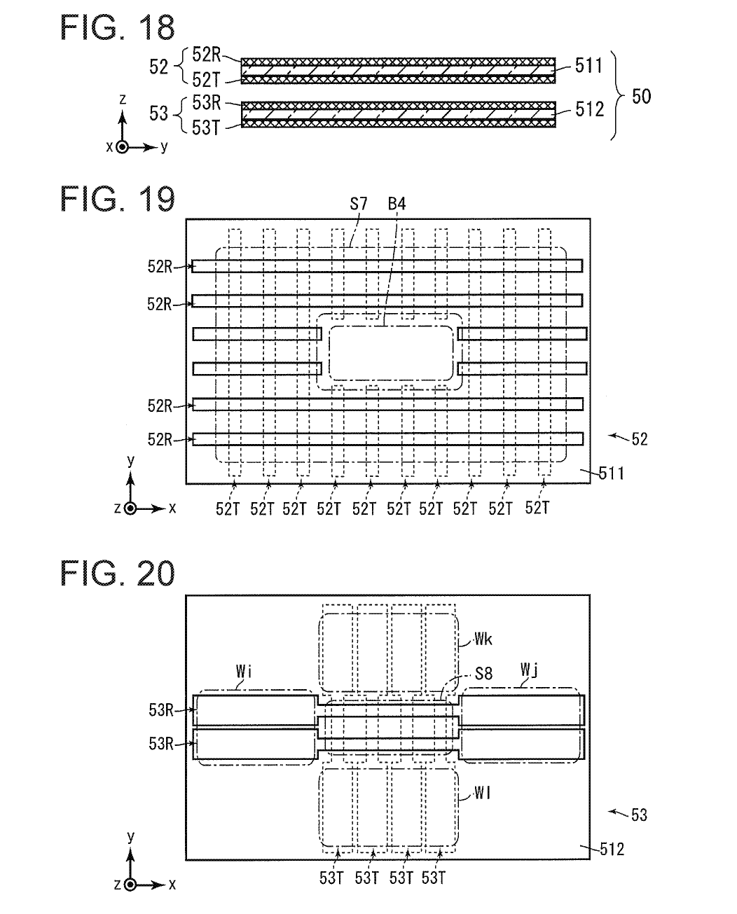

FIG. 18 is a cross-sectional view that shows a schematic configuration of a touch panel 50 according to Embodiment 2 of the present invention. The touch panel 50 includes a first substrate 511 and a second substrate 512. The first substrate 511 and the second substrate 512 are bonded together via an OCA. When the touch panel 50 is bonded to a liquid crystal display panel 20 (FIG. 1) to form a touch panel display device, the substrate 512 is disposed toward the liquid crystal display panel 20.

The first substrate 511 and the second substrate 512 are both transparent and have insulating properties. The first substrate 511 and the second substrate 512 are glass substrates, for example. The first substrate 511 and the second substrate 512 may be transparent resin films.

A first sensor unit 52 is formed on the first substrate 511, and a second sensor unit 53 is formed on the second substrate 512.

FIG. 19 is a plan view that shows a schematic configuration of the first substrate 511. The first sensor unit 52 includes a plurality of transmission electrodes 52T and a plurality of receiving electrodes 52R. The plurality of transmission electrodes 52T are formed in parallel to each other so as to each extend in the y direction. The plurality of receiving electrodes 52R are formed in parallel to each other so as to each extend in the x direction.

The transmission electrodes 52T and the receiving electrodes 52R are formed on different surfaces of the first substrate 511. As a result of such a configuration, it is possible to have the transmission electrodes 53T and the receiving electrodes 53R intersect in a plan view without contacting each other.

In FIGS. 18 and 19, the transmission electrodes 52T are formed on the surface of the first substrate 511 that faces toward the second substrate 512, and the receiving electrodes 52R are formed on the surface of the first substrate 511 opposite to the second substrate 512. However, the transmission electrodes 52T may be formed on the surface opposite to the second substrate 512 and the receiving electrodes 52R may be formed on the surface facing toward the second substrate 512.

The first sensor unit 52 has a first sensing region S7 formed such that the transmission electrodes 52T and the receiving electrodes 52R intersect in a plan view, and a blank region B4 in which no transmission electrodes 52T or receiving electrodes 52R are formed.

FIG. 20 is a plan view that shows a schematic configuration of the second substrate 512. The second sensor unit 53 includes a plurality of transmission electrodes 53T and a plurality of receiving electrodes 53R. The plurality of transmission electrodes 53T are formed in parallel to each other so as to each extend in the y direction. The plurality of receiving electrodes 53R are formed in parallel to each other so as to each extend in the x direction.

As was the case with the first substrate 511, the transmission electrodes 53T and the receiving electrodes 53R are formed on different surfaces of the second substrate 512.

The second sensor unit 53 includes: a second sensing region S8 formed such that the transmission electrodes 53T and the receiving electrodes 53R intersect in a plan view, and wiring regions Wi to Wl on which either only transmission electrodes 52T or only receiving electrodes 52R are formed.

In the present embodiment as well, the second sensing region S8 is disposed so as to be to the inside of the blank region B4 in a plan view. Thus, the second sensing region S8 is not electrically shielded by the first sensor unit 52.

The width of the transmission electrodes 53T and the receiving electrodes 53R in the wiring regions Wi to Wl is larger than the width of the transmission electrodes 53T and the receiving electrodes 53R in the second sensing region S8. Thus, the electrical resistance per unit length of the transmission electrodes 53T and the receiving electrodes 53R in the wiring regions Wi to Wl is smaller than the electrical resistance per unit length of the transmission electrodes 53T and the receiving electrodes 53R in the second sensing region S8.

In the present embodiment as well, the time coefficient of the transmission routes becomes smaller as a result of having the wiring regions Wi to Wl. Thus, it is possible to reduce the amount of time necessary to measure the second sensing region S8. As a result, it is possible to reduce the amount of time necessary to measure the capacitance of the entire touch panel 50.

As in Embodiment 1, in the present embodiment, the arrangement of the first sensing region and the second sensing region can be chosen as appropriate if the second sensing region is inside of the blank region in a plan view.

### Other Embodiments

Embodiments of the present invention were described above, but the present invention is not limited to the above-mentioned embodiments, and various modifications are possible within the scope of the present invention. Also, the respective embodiments can be appropriately combined.

For example, in Embodiment 1, the first sensor unit 12 and the second sensor unit 13 were disposed on different surfaces of the substrate 11. However, the first sensor unit 12 and the second sensor unit 13 may be formed on the same surface of the substrate 11 with an insulating layer, for example, sandwiched between the sensor units, or the like, for example.

The touch panel display device 1 may include, instead of the liquid crystal display panel 20, an organic EL (electroluminescence) panel, a MEMS (microelectromechanical system) panel, or a plasma display panel.

### INDUSTRIAL APPLICABILITY

The present invention can be applied to the industry of touch panels and touch panel display devices.

1: A touch panel, comprising:
a first sensor unit that includes first transmission electrodes and first receiving electrodes;
a second sensor unit that includes second transmission electrodes and second receiving electrodes;
a transmission unit that provides a drive signal to the first transmission electrodes and the second transmission electrodes; and
a receiving unit that receives a plurality of output signals from the first receiving electrodes and the second receiving electrodes,
wherein the first sensor unit has a first sensing region where the first transmission electrodes and the first receiving electrodes intersect in a plan view, and a blank region where none of the first transmission electrodes and the first receiving electrodes are formed,
wherein the second sensor unit has a second sensing region where the second transmission electrodes and the second receiving electrodes intersect in a plan view, and a wiring region where either only the second transmission electrodes or only the second receiving electrodes are formed, and
wherein the second sensing region is formed so as to overlap the blank region in a plan view.

2: The touch panel according to claim 1, wherein an electrical resistance per unit length of the second transmission electrodes in the wiring region is lower than an electrical resistance per unit length of the second transmission electrodes in the second sensing region.

3: The touch panel according to claim 1, wherein an electrical resistance per unit length of the second receiving electrodes in the wiring region is lower than an electrical resistance per unit length of the second receiving electrodes in the second sensing region.

4: The touch panel according to claim 1, further comprising:
a substrate,
wherein the first sensor unit is formed on one surface of the substrate, and
wherein the second sensor unit is formed on another surface of the substrate.

5. The touch panel according to claim 1, further comprising:
a first substrate; and
a second substrate disposed so as to overlap the first substrate,
wherein the first sensor unit is formed on the first substrate, and
wherein the second sensor unit is formed on the second substrate.

6. The touch panel according to claim 5,
wherein the first transmission electrodes are formed on one surface of the first substrate,
wherein the first receiving electrodes are formed on another surface of the first substrate,
wherein the second transmission electrodes are formed on one surface of the second substrate, and
wherein the second receiving electrodes are formed on another surface of the second substrate.

7. A touch panel display device, comprising:
the touch panel according to claim 1; and
a display panel disposed on a side of the touch panel that faces the second sensor unit.
